(19) United States
(12) Patent Application Publication
(10) Pub. No.: US 2007/0233491 A1
(43) Pub. Date: Oct. 4, 2007

(54) Word pronunciation system and method for producing pronunciations having various special effects as based on the parameters corresponding to characteristics of words

(75) Inventor: Yaz-Tzung Wu, Taipei (TW)

Correspondence Address: REED SMITH LLP, Suite 1400, 3110 Fairview Park Drive, Falls Church, VA, 22042, US

(73) Assignee: Inventec Corporation

(21) Appl. No.: 11/394,238

(22) Filed: Mar. 31, 2006

(51) Int. Cl. G10L 13/08

(52) U.S. Cl. 704/260

(57) ABSTRACT

A system and method capable of producing word pronunciations having various special effects based on the parameters corresponding to the characteristics of words is provided. A plurality of word pronunciation files is stored in the word pronunciation database, with each of the word pronunciation files having its corresponding word pronunciation parameter; a plurality of word characteristic pronunciation files is provided in the word characteristic database, with each of the word characteristic pronunciation files having its own corresponding word characteristic parameter. Firstly, the system is to read a string of words through a read module. Then, the processing module is to read the word pronunciation file and word characteristic pronunciation file based on the word pronunciation parameter and word characteristic parameter corresponding to the word. Finally, a broadcast pronunciation file is generated by synthesizing the word pronunciation file and the word characteristic pronunciation file for broadcasting.

### BACKGROUND

1. Field of Invention

The invention relates to a word pronunciation generation system and method, and in particular to a word pronunciation system and method for producing pronunciations having various special effects as based on the parameters corresponding to the characteristics of words.

2. Related Art

Due to the rapid progress and development of modern science and technology, voice synthesis and voice recognition technologies have reached a rather mature stage. The applications of such technologies are enormous, such as the pronunciation generator used in a translator machine. In addition, it can be combined with the short message service of the mobile phone to produce a pronounced short message. The advantage and characteristic of this function is that, through the “pronounced short message” the user can get the meaning of the message by just hearing the contents of the message without having to read the message on a screen. This feature and function are especially convenient and beneficial to the visual handicap. In the early stage, the word pronunciation function is used in the electronic translator, so that the user may press the pronunciation key, then the system will produce the message pronunciation corresponding to what appears on the screen.

However, usually, upon pressing the related pronunciation key, the user may only hear the pronunciation of the message in a monotonous tone, which is rather dull and uninteresting. Moreover, certain passages of an article are frequently marked with underlines, various different colors, and character formats to emphasize its specific contents. Thus, if the text of an article is expressed in a single monotonous tone, the user/listener may not be able to perceive the specialty or the emphasized features of the passages in an article. As such, the entire article “sounds” relatively dull and uninteresting.

### SUMMARY OF THE INVENTION

In view of the above-mentioned drawbacks and shortcomings of the prior art, the object of the invention is to provide a system and method capable of producing word pronunciations having various special effects based on the parameters corresponding to the characteristics of the words, so that the user may control the various special effects of the word pronunciation output by utilizing the edited word, thus solving the problem of the prior art.

Therefore, to achieve the above-mentioned objects, the invention discloses a system capable of producing word pronunciation having various special effects based on the parameters corresponding to characteristics of the words, including a word pronunciation database, a word characteristic database, a read module, a processing module, a pronunciation synthesis module, and a broadcast module. Each of the constituting devices will be described in detail as follows.

The word pronunciation database is provided with a plurality of word pronunciation files with each of the word pronunciation files corresponds to a specific word pronunciation parameter.

The word characteristic database is provided with a plurality of word characteristic pronunciation files, with each of them corresponding to a word characteristic parameter.

The read module is used to read a string of words comprising at least a word, with each of the words having its own word pronunciation parameter and word characteristic parameter.

The processing module is used to read the corresponding word pronunciation file and word characteristic pronunciation file from the word pronunciation database and the word characteristic database according to the word pronunciation parameter and word characteristic parameter corresponding to the respective word.

The pronunciation synthesis module is used to synthesize the pronunciations of the word pronunciation file and the word characteristic pronunciation file corresponding to the respective word, and generate a synthesized pronunciation in a broadcast pronunciation file.

The broadcast module is used to broadcast the pronunciations of the respective pronunciation file.

Furthermore, the invention discloses a method capable of producing word pronunciations having various special effects based on the parameters corresponding to characteristics of the word, including the following steps:

(A) establishing a plurality of word pronunciation files, with each of the word pronunciation files corresponding to a respective word pronunciation parameter;

(B) establishing a plurality of word characteristic pronunciation files, with each of the word characteristic pronunciation files corresponding to a specific word characteristic parameter;

(C) reading a string of words including at least one word, each word having a corresponding word pronunciation parameter and a word characteristic parameter;

(D) reading the corresponding word pronunciation file and word characteristic pronunciation file based on the word pronunciation parameter and word characteristic parameter corresponding to each word;

(E) synthesizing the pronunciations of the word pronunciation file and the word characteristic pronunciation file corresponding to the respective word into the pronunciation of at least one broadcast pronunciation file; and

(F) broadcasting the respective broadcast pronunciation files.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given below for illustration only, and thus is not limitative of the present invention, wherein:

FIG. 1 is a block diagram of the system capable of producing word pronunciations having various special effects based on the parameters corresponding to characteristics of the words;

FIG. 2A is a flowchart of the method capable of producing word pronunciations having various special effects based on the parameters corresponding to characteristics of the words;

FIGS. 2B and 2C are the additional flowcharts of the method capable of producing word pronunciations having various special effects based on the parameters corresponding to characteristics of the words; FIG. 3A is a corresponding table of words vs. word pronunciation parameters utilized in the invention;

FIG. 3B is a word characteristic parameter corresponding table according to the invention; and

FIG. 3C is a schematic diagram of a string of words utilized to illustrate the principle of the invention of producing word pronunciations having various special effects based on the parameters corresponding to characteristics of the words according to an embodiment of the invention.

### DETAILED DESCRIPTION OF THE INVENTION

The purpose, construction, features, functions, and characteristics of the invention can be appreciated and understood more thoroughly through the following detailed description with reference to the attached drawings.

The invention discloses a system capable of producing word pronunciations having various special effects based on the parameters corresponding to characteristics of the words.

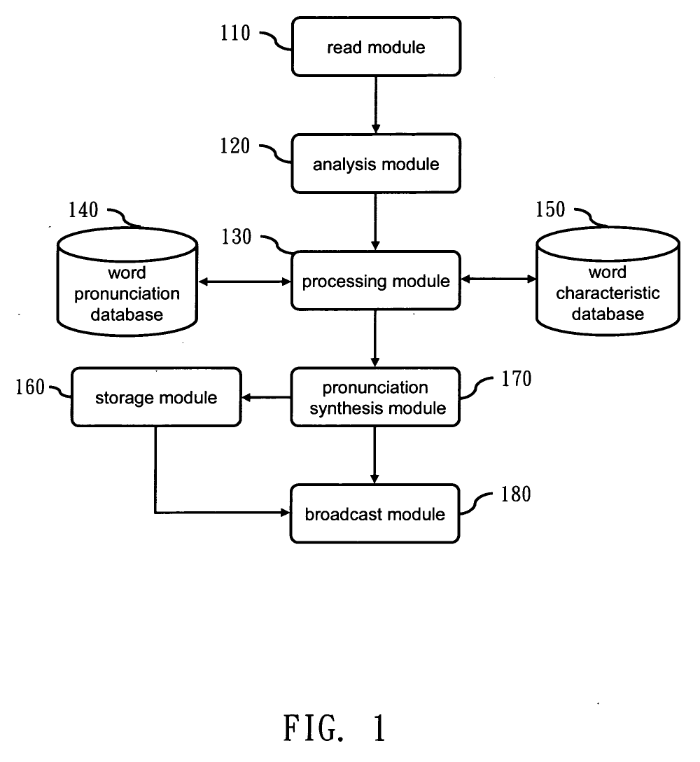

Firstly, refer to FIG. 1 for a block diagram of the system, capable of producing word pronunciations having various special effects based on the parameters corresponding to characteristics of the words, including a word pronunciation database 140, a word characteristic database 150, a read module 110, a processing module 130, a pronunciation synthesis module 170, and a broadcast module 180. Each of the above-mentioned constituting devices will be described in detail as follows.

The word pronunciation database 140 can be a storage device such as Read-Only-Memory (ROM), hard disk, memory card, and the like, and is provided with a plurality of word pronunciation files such as one of the following formats—‘.wav”, “.au”, “.snd”, “.voc”, “.aiff”, “.afc”, “.iff” or “.mat”. Each of the word pronunciation files is provided with the corresponding word pronunciation parameter. For instance, the word pronunciation parameter of “John” is set as “001”, and the word pronunciation parameter of “Wang” is set as “002”, and the pronunciation files of “John” “Wang” are provided in a word pronunciation database 140.

The word characteristic database 150 can be a storage device such as Read-Only-Memory (ROM), hard disk, memory card, and the like, and is provided with a plurality of word characteristic pronunciation files such as one of the following formats—‘.wav”, “.au”, “.snd”, “.voc”, “.aiff”, “.afc”, “.iff” or “.mat”. Each of the word characteristic pronunciation files corresponds to a specific word characteristic parameter. For instance, a word characteristic pronunciation file is corresponding to a word characteristic parameter such as the word characteristic pronunciation file of “Male adult voice” is set as “01”, and “Female adult voice” is set as “02”.

The read module 110 is used to read a string of words comprising one or more words, with each word having its own corresponding word pronunciation parameter and word characteristic parameter. The word characteristic parameter is used for editing a word based on its color, font, and size of the word. Namely, when a user edits a string of words, the respective word is provided with a set of corresponding word pronunciation parameters. In addition, when a given word is edited with other characteristics, the given word is provided with other corresponding word characteristic parameters. For example, the word pronunciation parameter of “Bill” is set as “001”, moreover, if the “King” is set to “black color”, then the black color characteristic is given a set of word characteristic parameter “01”, which corresponds to the “Male adult voice” of word characteristic parameter “01” in the word pronunciation file of the word characteristic database 150. In the word pronunciation database 140, the pronunciation of the word in the word pronunciation file is an ordinary mechanical tone.

The processing module 130 is used to read the corresponding word pronunciation file and the word characteristic pronunciation file from the word pronunciation database 140 and the word characteristic database 150 according to the word pronunciation parameter and word characteristic parameter corresponding to the respective word. For instance, the black color “Bill” is provided with the parameter “00101”, wherein “001” is the word pronunciation file parameter of “Bill”, so the processing module 130 can fetch the word pronunciation file of “Bill” from the word pronunciation database 140 according to the parameter “001”, whereas the last two numbers “01” is set as the word characteristic parameter of “black color”. Thus the processing module 130 can fetch the word characteristic pronunciation file of “Male adult voice” having the corresponding parameter “01” from the word characteristic database 150.

The pronunciation synthesis module 170 is used to generate a broadcast pronunciation file by synthesizing the word pronunciation file and the word characteristic pronunciation file read by the processing module 130 from the word pronunciation database 140 and the word characteristic database 150 respectively. For example, the pronunciation of a mechanical voice of “Bill” in the word pronunciation file and the pronunciation of “Male adult voice” in a word characteristic pronunciation file are synthesized into the pronunciation of a male adult voice of the word “Bill” in a broadcast pronunciation file.

The broadcast module 180 is used to broadcast the broadcast pronunciation file synthesized by the pronunciation synthesis module 170.

In addition, the system of the invention may further include an analysis module 120 and a storage module 160.

The analysis module 120 is connected to the processing module 130 and is used to analyze the word pronunciation parameter and word characteristic parameter of the respective word of a string of words, and transmitting the analysis results to the processing module 130.

The storage module 160 is connected to the pronunciation synthesis module 170 and is used to store the synthesized broadcast pronunciation file.

Furthermore, the invention discloses a method, capable of producing word pronunciations having various special effects based on the parameters corresponding to characteristics of the words.

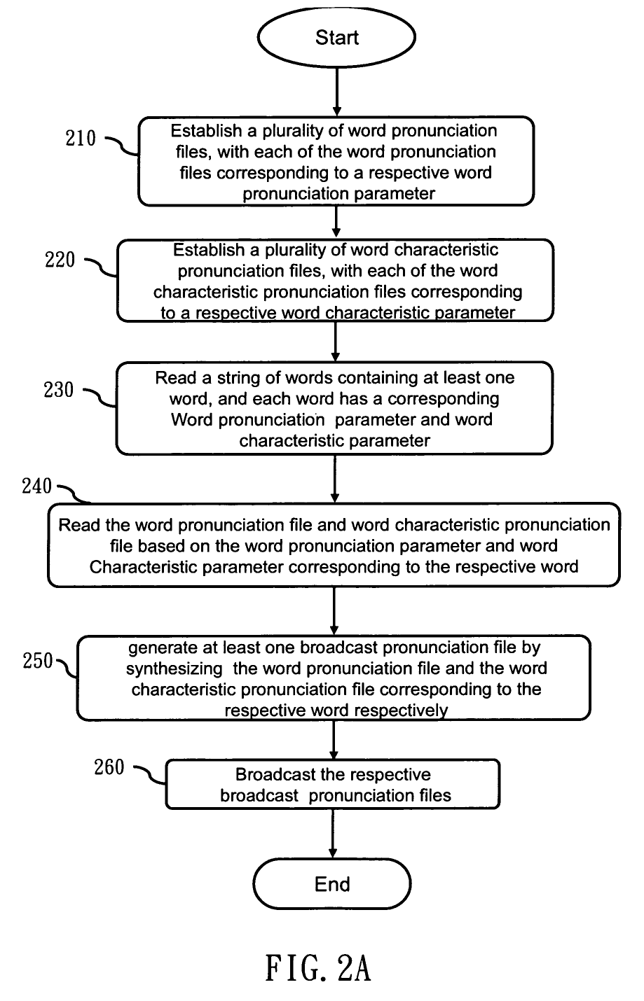

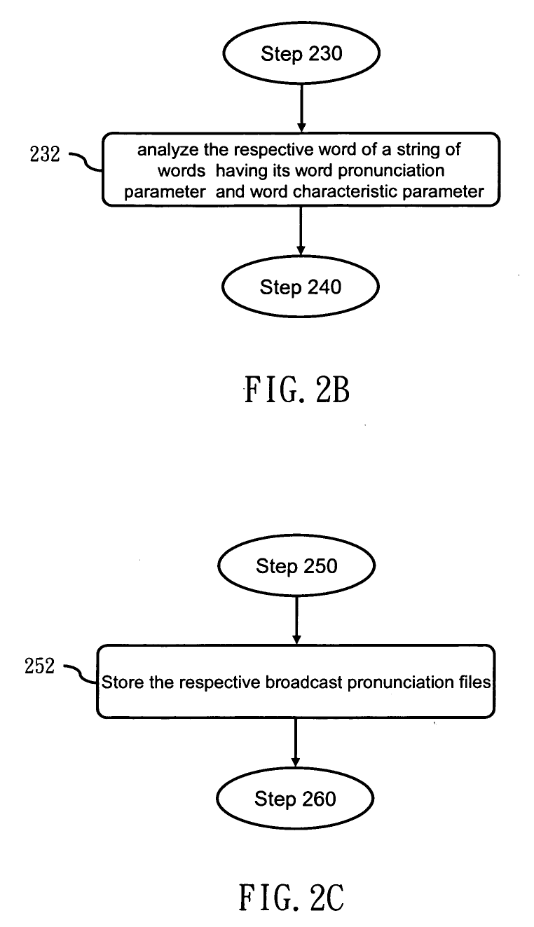

Refer to FIG. 2A for a system flowchart of a method capable of producing word pronunciations having various special effects based on the parameters corresponding to characteristics of the word. FIGS. 2B and 2C are the additional flowcharts of the method capable of producing word pronunciations having various special effects based on the parameters corresponding to characteristics of the words. The steps of the respective flowcharts will be described as follows.

Firstly, establish a plurality of word pronunciation files, with each of the word pronunciation files corresponding to a respective word pronunciation parameter (step 210), wherein the format of the word pronunciation file may be one of the following formats ‘.wav”, “.au”, “.snd”, “.voc”, “.aiff”, “.afc”, “.iff” or “.mat”.

Next, establish a plurality of word characteristic pronunciation files, with each of the word characteristic pronunciation files corresponding to a respective word characteristic parameter (step 220), wherein the format of the word pronunciation file may be one of the following formats ‘.wav”, “.au”, “.snd”, “.voc”, “.aiff”, “.afc”, “.iff” or “.mat”.

Then, read a string of words containing at least one word, and each word has a corresponding word pronunciation parameter and word characteristic parameter (step 230), wherein the respective word characteristic parameter is used to edit the pronunciation of the word according to the font, color, and size of the respective word.

Subsequently, analyze the respective word of a string of words having its word pronunciation parameter and word characteristic parameter (step 232). Then, read the word pronunciation file and word characteristic pronunciation file based on the word pronunciation parameter and word characteristic parameter corresponding to the respective word (step 240). Furthermore, generate at least one broadcast pronunciation file by synthesizing the word pronunciation file and the word characteristic pronunciation file corresponding to the respective word respectively (step 250). Then, store the respective broadcast pronunciation files (step 252). Finally, broadcast the respective broadcast pronunciation files (step 260).

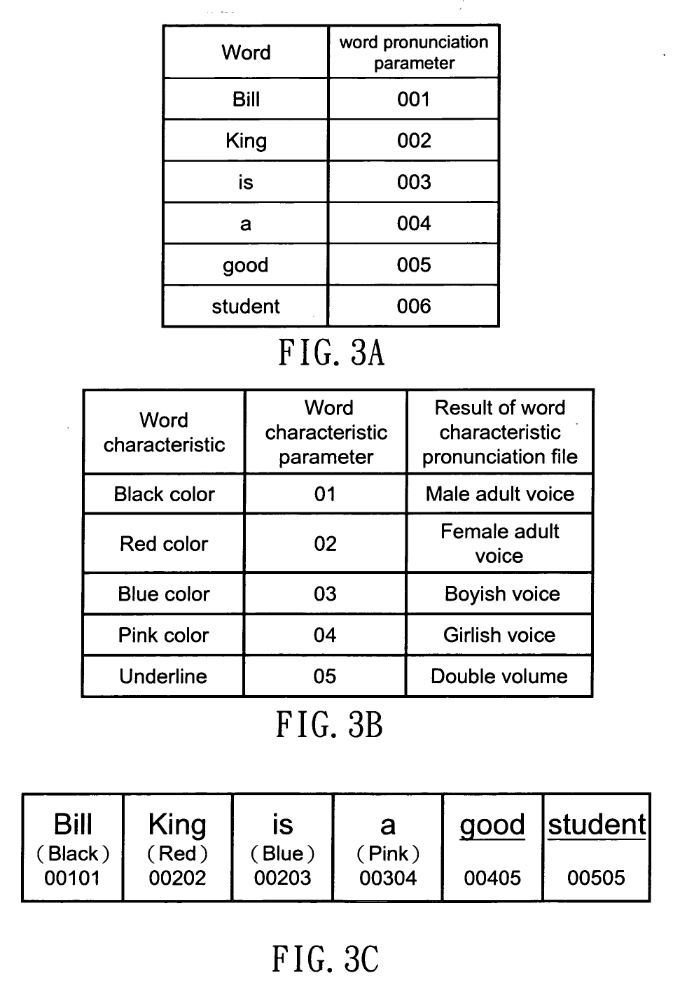

Moreover, refer to FIG. 3A for a corresponding table of words vs. word pronunciation parameters. FIG. 3B is a word characteristic parameter corresponding table according to the invention. FIG. 3C is a schematic diagram of a string of words utilized to illustrate the principle of the invention of producing word pronunciations having various special effects based on the parameters corresponding to characteristics of the words according to an embodiment of the invention.

In the present embodiment, the string of 6 words “Bill King is a good student” edited by the user is utilized to illustrate the principle in realizing the system and method of the invention, wherein, “Bill” is edited in black, “King” is edited in red, “Is” is edited in blue, “A” is edited in pink, “Good” is edited as an underlined word, and “Student” is also edited as an underlined word.

As such, the black color “Bill” is used to generate the parameter “00101”, wherein “001” is a word pronunciation parameter, and “01” is a word characteristic parameter. The red color “King” is used to generate the parameter “00202”, while the blue color “Is” is used to generate the parameter “00203”. Moreover, the pink color “A” is used to generate the parameter “00304”. Furthermore, the underlined “Good” is used to generate parameter “00405”, while the underlined “Student” is used to generate parameter “00505”.

Consequently, the word pronunciation parameter and the word characteristic parameter of the respective word is utilized to fetch the word pronunciation file and the word characteristic pronunciation file to synthesize a final broadcast pronunciation file. Thus, the black color “Bill” is pronounced [^{bIl}] in a “Male adult voice”, the red color “King” is pronounced [^{kIη}] in a “Female adult voice”, the blue color “Is” is pronounced [^{IZ}] in “a boyish voice”, the pink color “A” is pronounced [∂] in “a girlish voice”, and the underlined “Good” and “Student” are pronounced in doubled volume.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system capable of producing word pronunciations having various special effects based on the parameters corresponding to the characteristics of words, comprising:
a word pronunciation database, provided with a plurality of word pronunciation files with each of the word pronunciation files corresponding to a specific word pronunciation parameter respectively;
a word characteristic database, provided with a plurality of word characteristic pronunciation files corresponding to a word characteristic parameter respectively;
a read module, used to read a string of words comprising at least one word, with each word having the corresponding word pronunciation parameter and word characteristic parameter;
a processing module, used to read the corresponding word pronunciation file and the word characteristic pronunciation file from the word pronunciation database and the word characteristic database according to the word pronunciation parameter and the word characteristic parameter corresponding to the respective words;
a pronunciation synthesis module, used to generate at least one broadcast pronunciation file by synthesizing the word pronunciation file and the word characteristic pronunciation file; and
a broadcast module, used to broadcast the respective broadcast pronunciation files.

2. The system capable of producing word pronunciations having various special effects based on the parameters corresponding to the characteristics of words as claimed in claim 1, further comprising
an analysis module, used to analyze the word pronunciation parameter and the word characteristic parameter of the words of the string of words.

3. The system capable of producing word pronunciations having various special effects based on the parameters corresponding to the characteristics of words as claimed in claim 1, further comprising
a storage module, used to store the broadcast pronunciation file.

4. The system capable of producing word pronunciations having various special effects based on the parameters corresponding to the characteristics of words as claimed in claim 1, wherein the respective word characteristic parameter is edited according to the characteristics of the font, color, and size of the word.

5. The system capable of producing word pronunciations having various special effects based on the parameters corresponding to the characteristics of words as claimed in claim 1, wherein the formats of the word pronunciation file comprise ‘.wav”, “.au”, “.snd”, “.voc”, “.aiff”, “.afc”, “.iff” and “.mat”.

6. The system capable of producing word pronunciations having various special effects based on the parameters corresponding to the characteristics of words as claimed in claim 1, wherein the formats of the word characteristic pronunciation file comprise ‘.wav”, “.au”, “.snd”, “.voc”, “.aiff”, “.afc”, “.iff” and “.mat”.

7. A method capable of producing word pronunciations having various special effects based on the parameters corresponding to the characteristics of words, comprising the following steps:
establishing a plurality of word pronunciation files, with each of the word pronunciation files corresponding to a respective word pronunciation parameter;
establishing a plurality of word characteristic pronunciation files, with each of the word characteristic pronunciation files corresponding to a respective word characteristic parameter;
reading a string of words including at least one word, each word having a corresponding word pronunciation parameter and word characteristic parameter;
reading the word pronunciation file and the word characteristic pronunciation file based on the word pronunciation parameter and word characteristic parameter corresponding to the word;
generating at least one broadcast pronunciation file by synthesizing the word pronunciation file and the word characteristic pronunciation file corresponding to the respective word respectively; and
broadcasting the respective broadcast pronunciation files.

8. The method capable of producing word pronunciations having various special effects based on the parameters corresponding to the characteristics of words as claimed in claim 7, wherein the formats of the word pronunciation file comprise ‘.wav”, “.au”, “.snd”, “.voc”, “.aiff”, “.afc”, “.iff” and “.mat”.

9. The method capable of producing word pronunciations having various special effects based on the parameters corresponding to the characteristics of words as claimed in claim 7, wherein the formats of the word characteristic pronunciation file comprise ‘.wav”, “.au”, “.snd”, “.voc”, “.aiff”, “.afc”, “.iff” and “.mat”.

10. The method capable of producing word pronunciations having various special effects based on the parameters corresponding to the characteristics of words as claimed in claim 7, wherein the respective word characteristic parameter is edited according to the characteristics of the font, color, and size of the word.

11. The method capable of producing word pronunciations having various special effects based on the parameters corresponding to the characteristics of words as claimed in claim 7, wherein after the step of reading a string of words, further comprising the step of analyzing the word pronunciation parameter and the word characteristic parameter of the respective word of the string of words.

12. The method capable of producing word pronunciations having various special effects based on the parameters corresponding to the characteristics of words as claimed in claim 7, wherein after the step of generating at least one broadcast pronunciation file, further comprising the step of storing the broadcast pronunciation files.
